(19) United States
(12) Patent Application Publication
(10) Pub. No.: US 2024/0402784 A1
(43) Pub. Date: Dec. 5, 2024

(54) POWER SUPPLY WITH OVERCURRENT PROTECTION BASED ON SYSTEM BIOS SETTING

(71) Applicant: Lenovo (Singapore) Pte. Ltd., New Tech Park (SG)

(72) Inventors: Alan L. Painter, Apex, NC (US); Omar Ali, Cary, NC (US)

(21) Appl. No.: 18/325,450

(22) Filed: May 30, 2023

(51) Int. Cl. G06F 1/30

(52) U.S. Cl. CPC G06F 1/305

(57) ABSTRACT

An apparatus, system, and method are disclosed for automatically controlling a power setting of a power supply unit (PSU). The apparatus includes a processor and non-volatile memory having a switch configured to instruct the PSU to operate in a first overcurrent protection (OCP) mode.

### BACKGROUND

This invention relates to computer system configuration management and more particularly relates to overcurrent protections.

Power management becomes particularly important for computer workstations, which must rely upon a power source of the facility where the computer workstations are used.

### SUMMARY

Methods, apparatuses, and systems are disclosed for automatically controlling a power setting of a power supply unit (PSU). In one embodiment, the apparatus includes a processor and non-volatile memory having a switch configured to instruct the PSU to operate in a first overcurrent protection (OCP) mode.

In another embodiment, a system includes a processor, a power supply unit (PSU) coupled to the processor, and non-volatile memory comprising a switch configured to instruct the PSU to operate in a first overcurrent protection (OCP) mode.

In another embodiment, a method includes instructing a power supply unit (PSU) of a computer system to operate in a first overcurrent protection (OCP) mode based on a switch setting stored in non-volatile memory in the computer system and activating the switch upon start-up of the computer system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a possible computer system according to an embodiment;

FIG. 2 is a schematic block diagram of memory components according to an embodiment;

FIG. 3 is a screen shot of a basic input/output system (BIOS) setup utility according to an embodiment;

FIG. 4 is a schematic block diagram illustrating one embodiment of a method for a configuration module according to an embodiment; and

FIG. 5 is a schematic flow chart diagram illustrating one embodiment of a method for a configuration module according to an embodiment.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

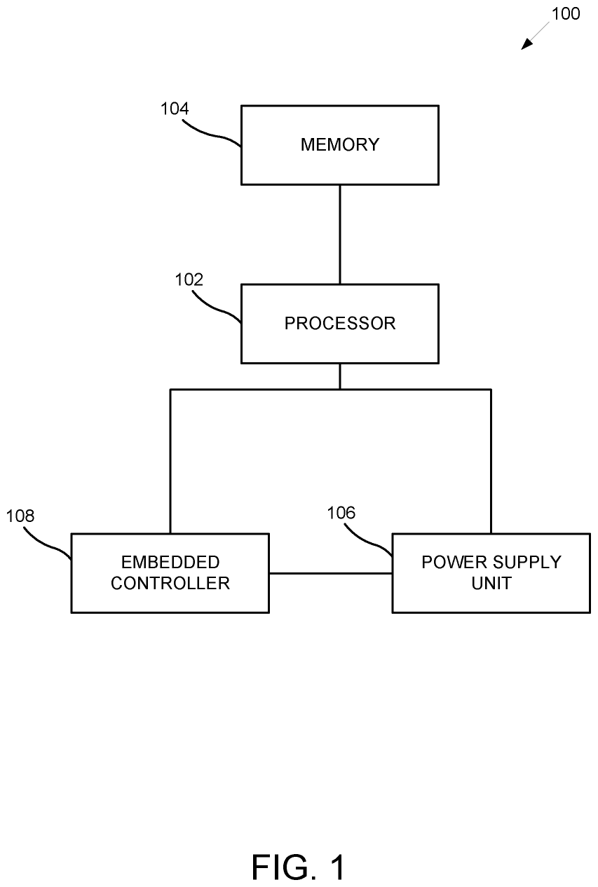

FIG. 1 is a schematic block diagram of the computer system 100 which is configurable to change overcurrent protection (OCP) limits depending upon the type of connector used by a power supply unit (PSU) 106. The computer system 100 includes at least a processor or a plurality of processor 102 (e.g., a central processing unit (CPU), a graphics processing unit (GPU), or the like), a memory 104, the PSU 106, and a motherboard embedded controller (EC) 108.

In one embodiment, there may different types of processors 102 having differing predetermined levels of power consumption. In an embodiment, the processors 102 may have different possible physical implementations, such as multi-chip, single chip, multi-core, hyperthreaded processors, and the like. Components of the computer system 100 receive power from the PSU 106. The PSU 106 may receive power from up to two or more predetermined types of power sources. In the example shown, one type of power source may arrive via a 20 amp (A) circuit and another type of power source may arrive via a 15 A circuit.

The memory 104 may be of any size or organization and may include both read/write and read-only sections. It may also include both global and local sections and may support both uniform and non-uniform access. It may incorporate memory-mapped I/O and direct memory access.

The EC 108 controls operations of components located on a motherboard. The EC 108 receives signals from the processor 102 and/or the PSU 106 for controlling motherboard components so as not to overload the PSU 106.

An exemplary computer system 100 may be a desk-side tower workstation configured to consume over 1250 watts (W) via the PSU 106 having a C20 receptacle (i.e., 20 A input) using a national electrical manufacturers association (NEMA) 5-20P plug. However, not all customer configurations and/or environments can support a NEMA 5-20P plug. For example, a residential location may only include 120 volt (V), 15 A outlets. Thus, the computer system 100 is configurable to be useable with the PSU 106 coupled to a 15 A input using a NEMA 5-15P plug. The processor 102 upon executing instructions stored in the memory 104 allows the use of a standard NEMA 5-15P plug by signaling to the PSU 106 to use an alternate OCP threshold (i.e., limits or values) that aligns with a 15 A input.

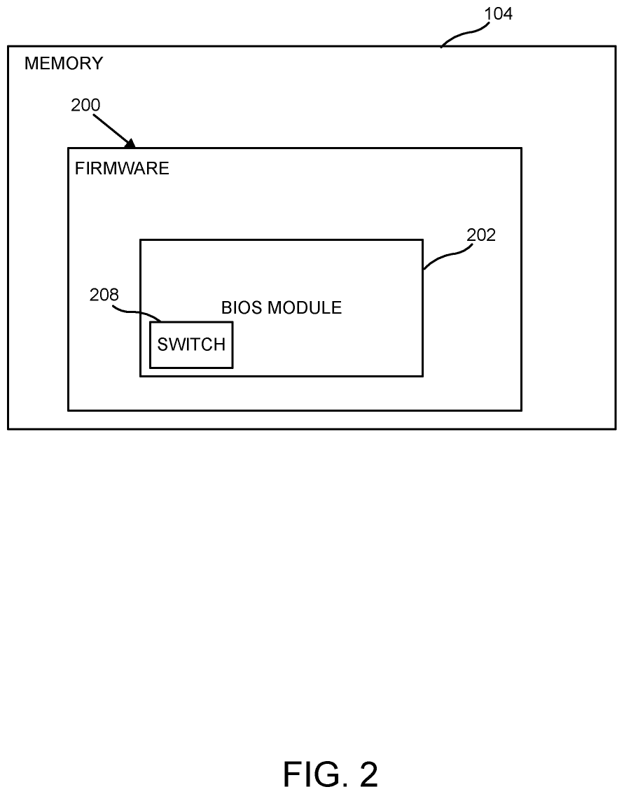

In various embodiments, referring to FIG. 2, the memory 104 includes instructions stored on non-transitory computer readable medium. The instructions are stored in software and firmware 200. The firmware 200 includes a configurable basic input/output system (BIOS) module 202 used to start the computer system 100 and to manage data flow between an operating system of the computer system 100 and attached devices. The BIOS module 202 includes a BIOS power setting switch 208 that may indicate any of the following:
assertion of a first or a second over-current protection (OCP) mode; or
deassertion of the first or a second over-current protection (OCP) mode.

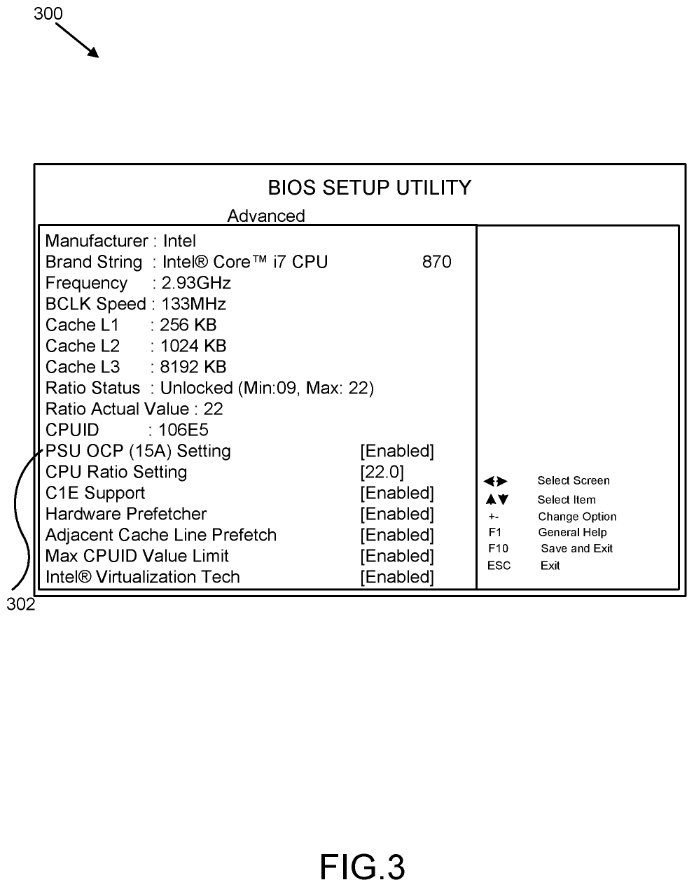

The BIOS power setting switch 208 may be set by a manufacturer of the computer system 100 or a user. The BIOS power setting switch 208 may be defaulted to either the 15 A mode or the 20 A mode. Referring to FIG. 3, in one embodiment, applying a label of “Enabled” to the BIOS power setting switch 208 within a BIOS setup utility 300 will set the 15 A mode.

In one embodiment, the BIOS power setting switch 208 causes the computer system 100 to assert or deassert a general-purpose input/output (GPIO) to the PSU 106, thus allowing the PSU 106 to select appropriate DC output OCP values. The EC 108 may also receive the asserted or deasserted GPIO along with a low voltage alternating current (VAC) input signal from the PSU 106. In response, the EC 108 measures incoming current to the motherboard and implements an associated OCP. OCP values for the 20 A mode allow a maximum of 20 A or less AC input current, accounting for power factor, efficiency, and AC voltage detected by the PSU 106. Likewise, the 15 A mode allows a maximum of 15 A or less AC input current. The 20 A mode is used, when a NEMA 5-20P power cord is configured with the system. The 15 A mode is used, when a NEMA 5-20P power cord is configured with the system.

With regard to power limitation, the EC 108 may detect if the BIOS is set in 15 A mode and if only one PSU 106 is installed. If both of those conditions are true, then the EC 108 monitors current coming into the motherboard to duplicate the OCP triggers of the PSU 106. If the current is high for too long, the EC 108 will first try to reduce current by asserting PROC_HOT on a CPU and POWER_BRAKE on a GPU(s).

In various embodiments, the firmware 200 may include microcode, which may reside in a microstore of the processor(s) 102. In an embodiment, the firmware 200 may include low-level software, which may reside in memory 104. In one embodiment, the firmware 200 may include a rudimentary operating system. In a further embodiment, the firmware 200 may support virtualization so as to permit concurrent operation of multiple operating systems on a computer system 100.

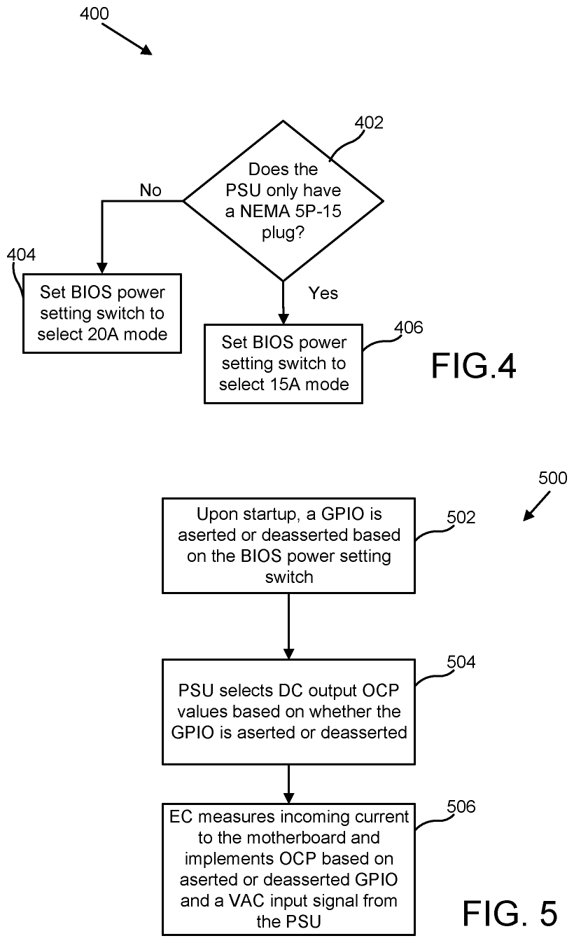

FIG. 4 is a schematic flow chart diagram illustrating one embodiment of a method 400 for configuring a computer system to be used with different power connection configurations. The method 400 starts at a decision block 402 where a manufacturer or a user of the computer system determines if a PSU of the computer system includes a NEMA 5-15P plug. If the computer system includes a NEMA 5-15P plug, at a block 406, the manufacturer or the user sets a BIOS power setting switch to select a 15 A mode. If the PSU does not include a NEMA 5-15P plug (but a NEMA 5-20P plug), at a block 404, the manufacturer or the user sets the BIOS power setting switch to select a 20 A mode or leaves the BIOS power setting switch in a default state which is the 20 A mode.

FIG. 5 is a schematic flow chart diagram illustrating one embodiment of a method 500 for automatically configuring the computer system based on the settings applied in method 400. At a block 502, the computer system upon startup, a GPIO is asserted or deasserted based on the BIOS power setting switch. At a block 504, the PSU selects direct current (DC) output OCP values based on whether the GPIO is asserted or deasserted. At a block 506, an EC of the computer system measures incoming current to a motherboard and implements OCP based on the asserted or deasserted GPIO and a VAC input signal from the PSU.

### Embodiments

A. An apparatus comprising: a processor; and a non-volatile memory comprising a switch configured to instruct the PSU to operate in a first overcurrent protection (OCP) mode.

B. The apparatus of A, wherein the switch is included in a basic input/output system (BIOS) module.

C. The apparatus of A or B, wherein the OCP mode is a 15 A mode.

D. The apparatus of C, wherein the OCP mode is a 20 A mode.

E. The apparatus of any of A-D, further comprising a motherboard embedded controller (EC) coupled to the processor, wherein the switch is configured to instruct the EC to operate in one of a plurality OCP modes.

F. The apparatus of E, wherein the EC is configured to use an OCP threshold associated with a 15 A input responsive to the OCP mode being a 15 A mode.

G. A system comprising: a processor; a power supply unit (PSU) coupled to the processor; non-volatile memory comprising a switch configured to instruct the PSU to operate in a first OCP mode.

H. The system of G, wherein the switch is included in a basic input/output system (BIOS) module.

I. The system of G or H, wherein the OCP mode is a 15 A mode.

J. The system of I, wherein the OCP mode is a 20 A mode.

K. The system of I or J, wherein the PSU is configured to use an OCP threshold associated with a 15 A input responsive to the OCP mode being the 15 A mode.

L. The system of any of G-K, further comprising a motherboard embedded controller (EC) coupled to the processor, wherein the switch is configured to instruct the EC to operate in one of a plurality OCP modes.

M. The system of L, wherein the EC is configured to use an OCP threshold associated with a 15 A input responsive to the OCP mode being a 15 A mode.

N. A method comprising instructing a power supply unit (PSU) of a computer system to operate in a first OCP mode based a switch setting stored in non-volatile memory in the computer system and activating the switch upon start-up of the computer system.

O. The method of N, wherein the switch is included in a basic input/output system (BIOS) module.

P. The method of N or O, wherein the OCP mode is a 15 A mode.

Q. The method of P, wherein the OCP mode is a 20 A mode.

R. The method of P, further comprising at the PSU, using an OCP threshold associated with a 15 A input responsive to the OCP mode being the 15 A mode.

S. The method of any of N—R, further comprising instructing a motherboard embedded controller (EC) to operate in one of a plurality overcurrent protection (OCP) modes.

T. The method of S, further comprising, at the EC, using an OCP threshold associated with a 15 A input responsive to the OCP mode being a 15 A mode.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a processor; and
a non-volatile memory comprising a switch configured to instruct a power supply unit (PSU) to operate in a first overcurrent protection (OCP) mode.

2. The apparatus of claim 1, wherein the switch is included in a basic input/output system (BIOS) module.

3. The apparatus of claim 1, wherein the switch asserts a general-purpose input/output associated with the PSU.

4. The apparatus of claim 3, wherein the switch deasserts a general-purpose input/output associated with the PSU.

5. The apparatus of claim 1, further comprising a motherboard embedded controller (EC) coupled to the processor,
wherein the switch is configured to instruct the EC to operate in one of a plurality overcurrent protection (OCP) modes.

6. The apparatus of claim 5, wherein the EC is configured to use an OCP threshold associated with a 15 A input responsive to the OCP mode being a 15 A mode.

7. A system comprising:
a processor
a power supply unit (PSU) coupled to the processor; and
non-volatile memory comprising a switch configured to instruct the PSU to operate in a first overcurrent protection (OCP) mode.

8. The system of claim 7, wherein the switch is included in a basic input/output system (BIOS) module.

9. The system of claim 7, wherein the switch asserts a general-purpose input/output associated with the PSU.

10. The system of claim 9, wherein the switch deasserts a general-purpose input/output associated with the PSU.

11. The system of claim 7, wherein the PSU is configured to use an OCP threshold associated with a 15 A input responsive to the OCP mode being a 15 A mode.

12. The system of claim 7, further comprising a motherboard embedded controller (EC) coupled to the processor,
wherein the switch is configured to instruct the EC to operate in one of a plurality overcurrent protection (OCP) modes.

13. The system of claim 12, wherein the EC is configured to use an OCP threshold associated with a 15 A input responsive to the OCP mode being a 15 A mode.

14. A method comprising:
instructing a power supply unit (PSU) of a computer system to operate in a first overcurrent protection (OCP) mode based a switch setting stored in non-volatile memory in the computer system; and
activating the switch upon start-up of the computer system.

15. The method of claim 14, wherein the switch is included in a basic input/output system (BIOS) module.

16. The method of claim 14, wherein the switch asserts a general-purpose input/output associated with the PSU.

17. The method of claim 16, wherein the switch deasserts a general-purpose input/output associated with the PSU.

18. The method of claim 14, further comprising:
at the PSU, using an OCP threshold associated with a 15 A input responsive to the OCP mode being a 15 A mode.

19. The method of claim 14, further comprising instructing a motherboard embedded controller (EC) to operate in one of a plurality overcurrent protection (OCP) modes.

20. The method of claim 19, further comprising, at the EC, using an OCP threshold associated with a 15 A input responsive to the OCP mode being a 15 A mode.
